(19) United States
(12) Patent Application Publication
(10) Pub. No.: US 2018/0068215 A1
(43) Pub. Date: Mar. 8, 2018

(54) BIG DATA PROCESSING METHOD FOR SEGMENT-BASED TWO-GRADE DEEP LEARNING MODEL

(71) Applicants: INSTITUTE OF ACOUSTICS, CHINESE ACADEMY OF SCIENCES, Beijing (CN); SHANGHAI 3NTV NETWORK TECHNOLOGY CO. LTD., Shanghai (CN)

(72) Inventors: Jinlin WANG, Beijing (CN); Jiali YOU, Beijing (CN); Yiqiang SHENG, Beijing (CN); Chaopeng LI, Beijing (CN)

(73) Assignees: INSTITUTE OF ACOUSTICS, CHINESE ACADEMY OF SCIENCES, Beijing (CN); SHANGHAI 3NTV NETWORK TECHNOLOGY CO. LTD., Shanghai (CN)

(21) Appl. No.: 15/557,463

(22) PCT Filed: Mar. 31, 2015
(86) PCT No.: PCT/CN2015/075472

§ 371 Date: Sep. 11, 2017

(30) Foreign Application Priority Data
Mar. 13, 2015 (CN) 201510111904.6

(51) Int. Cl. G06N 3/04; G06N 3/08

(52) U.S. Cl. CPC G06N 3/04; G06N 3/08

(57) ABSTRACT

A big data processing method for a segment-based two-grade deep learning model. The method includes: step (1), constructing and training a segment-based two-grade deep learning model, wherein the model is divided into two grades in a longitudinal level: a first grade and a second grade, each layer of the first grade is divided into M segments in a horizontal direction, and the weight between neuron nodes of adjacent layers in different segments of the first grade is zero; step (2), dividing big data to be processed into M sub-sets according to the type of the data and respectively inputting same into M segments of a first layer of the segment-based two-grade deep learning model for processing; and step (3), outputting a big data processing result. The method of the present invention can increase the big data processing speed and shorten the processing time.

### CROSS REFERENCE TO RELATED APPLICATIONS

This application is the national phase entry of International Application No. PCT/CN2015/075472, filed on Mar. 31, 2015, which is based upon and claims priority to Chinese Patent Application No. CN201510111904.6, filed on Mar. 13, 2015, the entire contents of which are incorporated herein by reference.

### TECHNICAL FIELD

The present invention relates to the field of artificial intelligence and big data, and in particular, to a big data processing method for a segment-based two-grade deep learning model.

### BACKGROUND OF THE INVENTION

With the rapid development of network technologies, data volume and data diversity increase rapidly, but it is difficult to improve the complexity of the algorithms for data processing, thus how to effectively processing big data has become an urgent problem. The existing methods for data description, data labelling, feature selection, feature extraction and data processing depending on personal experiences and manual operation can hardly meet the requirements of the fast growth of big data. The rapid development of artificial intelligence technologies, especially the breakthrough of the investigation on deep learning algorithms, indicates a direction worth exploring of solving the problem of big data processing.

Hinton, et al, proposed a layer-by-layer initialization training method for a deep belief network in 2006. This is a starting point of the investigation on deep learning methods, which breaks the situation of difficult and inefficient deep neural network training that lasts decades of years. Thereafter, deep learning algorithms are widely used in the fields of image recognition, speech recognition and natural language understanding, etc. By simulating the hierarchical abstraction of human brains, deep learning can obtain a more abstract feature via mapping bottom data layer by layer. Because it can automatically abstract a feature from big data and obtain a good processing effect via massive sample training, deep learning gets wide attention. In fact, the rapid growth of big data and the breakthrough of investigation on deep learning supplement and promote each other. On one hand, the rapid growth of big data requires a method for effectively processing massive data; on the other hand, the training of a deep learning model needs massive sample data. In short, by big data, the performance of deep learning can reach perfection.

However, the existing deep learning model has many serious problems, for example, difficult model extension, difficult parameter optimization, too long training time and low reasoning efficiency, etc. A review paper of Bengio, 2013 summarizes the challenges and difficulties faced by the current deep learning, which includes: how to expand the scale of an existing deep learning model and apply the existing deep learning model to a larger data set; how to reduce the difficulties in parameter optimization; how to avoid costly reasoning and sampling; and how to resolve variation factors, etc.

### SUMMARY OF THE INVENTION

It is an object of the present invention to overcome the above problems of an existing neural network deep learning model in the application of big data and propose a segment-based two-grade deep learning model. The expansion capability of the model can be improved by grading and segmenting the deep learning model and restricting the weight of segments. Based on the model, the present invention proposes a big data processing method for a segment-based two-grade deep learning model, which can increase the big data processing speed and shorten the processing time.

In order to attain the above object, the present invention provides a big data processing method for a segment-based two-grade deep learning model, the method comprising:

step (1) constructing and training a segment-based two-grade deep learning model, wherein the model is divided into two grades in a longitudinal level: a first grade and a second grade; each layer of the first grade is divided into M segments in a horizontal direction; wherein, M is a modality number of a multimodality input, and a weight between neuron nodes of adjacent layers in different segments of the first grade is 0;

step (2) dividing big data to be processed into M sub-sets according to a type of the data, and respectively inputting same into M segments of a first layer of the segment-based two-grade deep learning model for processing; and

step (3) outputting a big data processing result.

In the above technical solution, the step (1) further comprising:

step (101) dividing a deep learning model with a depth of L layers into two grades in a longitudinal level, i.e., a first grade and a second grade:

wherein, an input layer is a first layer, an output layer is an L^{th} layer, and an (L*)^{th} layer is a division layer, 2≦L*≦L−1, then all the layers from the first layer to the (L*)^{th} layer are referred to as the first grade, and all the layers from an (L*+1)^{th} layer to the L^{th} layer are referred to as the second grade;

step (102): dividing neuron nodes on each layer of the first grade into M segments in a horizontal direction:

let an input width of the L-layer neural network be N, that is, each layer has N neuron nodes, the neuron nodes of the first grade are divided into M segments, and a width of each segment is Dₘ, 1≦m≦M and Σₘ₌₁^{M}Dₘ=N, and in a same segment, widths of any two layers are the same;

step (103) dividing training samples into M sub-sets, and respectively inputting same into the M segments of the first layer of the deep learning model;

step (104) respectively training the sub-models of the M segments of the first grade:

the weight between neuron nodes of adjacent layers in different segments of the first grade is 0, that is, a set of all the nodes of the m^{th} segment is Sₘ, any node of the (l−1)^{th} layer is sᵢ_{^{(m)}}_{,l-1}εSₘ, wherein 2≦l≦L*, while any node of the l^{th} layer of the o^{th} segment is sⱼ_{^{(o)}}_{,l}εSₒ and m≠o, then a weight between node sᵢ_{^{(m)}}_{,l-1} and sⱼ_{^{(o)}}_{,l} node is 0, i.e., wᵢ_{^{(m)}}_{,j,}_{^{(o)}}_{,l}=0;

under the above constraint conditions, the sub-models of the M segments of the first grade are respectively trained via a deep neural network learning algorithm;

step (105): training each layer of the second grade; and

step (106): globally fine-tuning a network parameter of each layer via the deep neural network learning algorithm, till the network parameter of each layer reaches an optimal value.

In the above technical solutions, a value of L* is taken by determining an optimal value in a value interval of L* via a cross validation method.

The present invention has the following advantages:

(1) the segment-based two-grade deep learning model proposed by the present invention effectively reduces the scale of a model, and shortens the training time of the model;

(2) the big data processing method proposed by the present invention supports parallel input of multisource heterogeneous or multimodality big data, increases the big data processing speed, and shortens the processing time.

### BRIEF DESCRIPTION OF THE DRAWINGS

FIG. 1 is a flowchart of a big data processing method for a segment-based two-grade deep learning model of the present invention; and

FIG. 2 is a schematic diagram of a segment-based two-grade deep learning model.

### DETAILED DESCRIPTION OF THE INVENTION

Further detailed description on the method of the present invention will be given below in conjunction with the drawings.

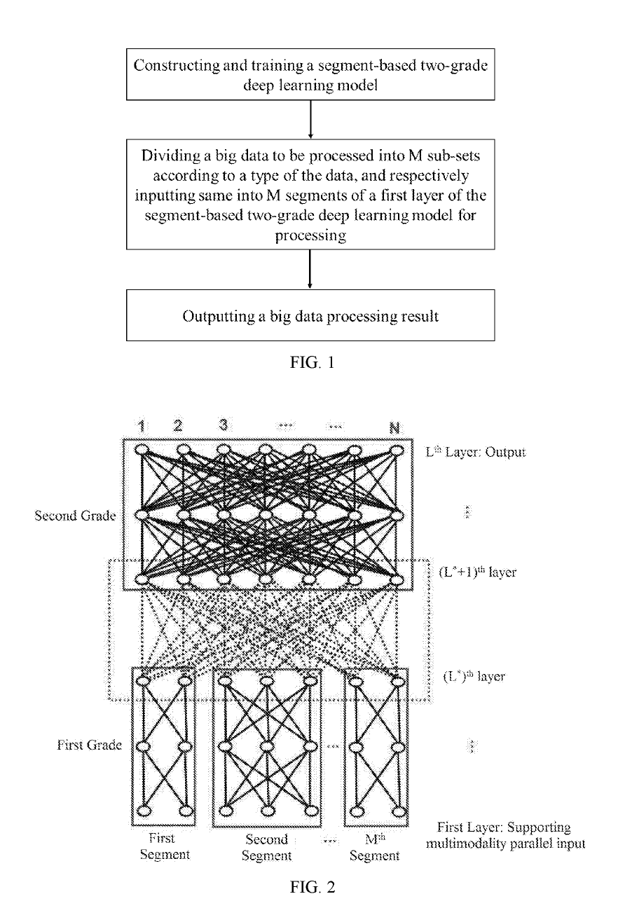

As shown in FIG. 1, a big data processing method for a segment-based two-grade deep learning model comprises:

step (1) constructing and training a segment-based two-grade deep learning model, which comprises:

step (101) dividing a deep learning model with a depth of L^{th} layers into two grades in a longitudinal direction, i.e., a first grade and a second grade:

wherein, an input layer is a first layer, an output layer is an L^{th} layer, and an (L*)^{th} layer is a division layer, wherein 2≦L*≦L−1, then all the layers from the first layer to the (L*)^{th} layer are referred to as the first grade, and all the layers from an (L*+1)^{th} layer to the L^{th} layer are referred to as the second grade; and

a value of L* is taken by determining an optimal value in a value taking interval of L* via a cross validation method;

step (102) dividing neuron nodes on each layer of the first grade into M segments in a horizontal direction; wherein, M is a modality number of a multimodality input;

as shown in FIG. 2, it can be set that an input width of the L-layer neural network is N, that is, each layer has N neuron nodes, the neuron nodes of the first grade are divided into M segments, and a width of each segment is Dₘ, 1≦m≦M and Σₘ₌₁^{M}Dₘ=N, and in a same segment, widths of any two layers are the same;

step (103) dividing training samples into M sub-sets, and respectively inputting same into the M segments of the first layer of the deep learning model;

step (104) respectively training sub-models of the M segments of the first grade;

the weight between neuron nodes of adjacent layers in different segments of the first grade is 0, that is, a set of all the nodes of the m^{th} segment is Sₘ, any node of the (l−1)^{th} layer is sᵢ_{^{(m)}}_{,l-1}εSₘ, wherein 2≦l≦L*, while any node of the l^{th} layer of the o^{th} segment is sⱼ_{^{(o)}}_{,l}εSₒ, and m≠o, then a weight between node sᵢ_{^{(m)}}_{,l-1} and node sⱼ_{^{(o)}}_{,l} is 0, i.e., wᵢ_{^{(m)}}_{,j}_{^{(o)}}_{,l}=0;

under the above constraint conditions, the sub-models of the M segments of the first grade are respectively trained via a deep neural network learning algorithm;

step (105) training each layer of the second grade; and

step (106) globally fine-tuning a network parameter of each layer via the deep neural network learning algorithm, till the network parameter of each layer reaches an optimal value;

wherein, the deep neural network learning algorithm is a BP algorithm;

step (2) dividing big data to be processed into M sub-sets according to a type of the data, and respectively inputting same into M segments of the first layer of the segment-based two-grade deep learning model for processing; and

step (3) outputting a big data processing result.

Finally, it should be noted that the above embodiments are merely used to illustrate, rather than limit, the technical solutions of the present invention. Although the present invention has been illustrated in detail referring to the embodiments, it should be understood by one of ordinary skills in the art that the technical solutions of the present invention can be modified or equally substituted without departing from the spirit and scope of the technical solutions of the present invention. Therefore, all the modifications and equivalent substitution should fall into the scope of the claims of the present invention.

What is claimed is:

1. A big data processing method for a segment-based two-grade deep learning model, the method comprising:
step (1) constructing and training the segment-based two-grade deep learning model, wherein the segment-based two-grade deep learning model is divided into two grades in a longitudinal level: a first grade and a second grade; each layer of the first grade is divided into M segments in a horizontal direction; wherein, M is a modality number of a multimodality input, and a weight between neuron nodes of adjacent layers in different segments of the first grade is 0;
step (2) dividing a big data to be processed into M sub-sets according to a type of the data, and respectively input into M segments of a first layer of the segment-based two-grade deep learning model for processing; and
step (3) outputting a big data processing result.

2. The big data processing method for a segment-based two-grade deep learning model of claim 1, wherein, the step (1) further comprises:
step (101) dividing the segment-based two-grade deep learning model with a depth of L layers into two grades in the longitudinal level: the first grade and the second grade;
wherein, an input layer is a first layer, an output layer is an L^{th} layer, and an (L*)^{th} layer is a division layer, 2≦L*≦L−1, then all the layers from the first layer to the (L*)^{th} layer are referred to as the first grade, and all the layers from an (L*+1)^{th} layer to the L^{th} layer are referred to as the second grade;
step (102) dividing neuron nodes on each layer of the first grade into M segments in a horizontal direction:
wherein an input width of the L-layer neural network is N, and each layer has N neuron nodes, the neuron nodes of the first grade are divided into M segments, and a width of each segment is Dₘ, 1≦m≦M and Σₘ₌₁^{M}Dₘ=N, and in a same segment, widths of any two layers are the same;
step (103) dividing a training sample into M sub-sets, and respectively input into the M segments of the first layer of the deep learning model;
step (104) respectively training sub-models of the M segments of the first grade:
the weight between neuron nodes of adjacent layers in different segments of the first grade is 0, whereby a set of all the nodes of the m^{th} segment is Sₘ, any node of the (l−1)^{th} layer is sᵢ_{^{(m)}}_{,l-1}εSₘ, wherein 2≦l≦L*, while any node of the l^{th} layer of the o^{th} segment is sⱼ_{^{(o)}}_{,l}εSₒ and m≠o, then a weight between node sᵢ_{^{(m)}}_{,l-1} and node sⱼ_{^{(o)}}_{,l} is 0, whereby wᵢ_{^{(m)}}_{,j}_{^{(o)}}_{,l}=0;
wherein, the sub-models of the M segments of the first grade are respectively trained via a deep neural network learning algorithm;
step (105) training each layer of the second grade; and
step (106) globally fine-tuning a network parameter of each layer via the deep neural network learning algorithm, till the network parameter of each layer reaches an optimal value.

3. The big data processing method for a segment-based two-grade deep learning model of claim 2, wherein, a value of L* is taken by determining an optimal value in a value taking interval of L* via a cross validation method.
